(19) United States
(12) Patent Application Publication
(10) Pub. No.: US 2014/0063353 A1
(43) Pub. Date: Mar. 6, 2014

(54) VARIABLE BRIGHTNESS DIGITAL SIGNAGE

(71) Applicants: John C. Schultz, Afton, MN (US); Quinn D. Sanford, Ellsworth, WI (US); Nicholas A. Johnson, Burnsville, MN (US)

(72) Inventors: John C. Schultz, Afton, MN (US); Quinn D. Sanford, Ellsworth, WI (US); Nicholas A. Johnson, Burnsville, MN (US)

(73) Assignee: 3M Innovative Properties Company

(21) Appl. No.: 13/603,680

(22) Filed: Sep. 5, 2012

(51) Int. Cl. G03B 21/56; H04N 9/31; G09G 5/10

(52) U.S. Cl. 348/744; 359/460; 345/690; 348/E09.025

(57) ABSTRACT

A system for projecting content onto a shaped screen and highlighting particular portions of the content. The system includes a projector configured for projecting content having a particular shape and a rear projection screen for receiving and displaying the projected content. The rear projection screen has a shape substantially conforming to the particular shape of the content. The system is configured to increase or maximize an illumination of the projected content in a particular portion of the rear projection screen compared with the projected content in other portions of the screen. The increased illumination can be used to highlight the projected content in the particular portion for digital merchandising or other uses.

### BACKGROUND

Consumers have become inundated with static image content at the point of purchase. The static image content typically promotes or provides information about products in an attempt to influence consumers' purchasing decisions. However, determining the effectiveness of such static image content can be difficult. There is thus a need for new ways to attract the attention of consumers in providing them with advertisements or other product promotional content. One approach involves converting these static surfaces to video surfaces and providing video content for advertisements, attempting to attract consumers' attention through an active type of content. This video content is typically provided on flat screen display devices, such as liquid crystal display devices, proximate or near the product being promoted. The effectiveness of this type of advertisement may be limited when the consumers are simply viewing potential products to purchase and not viewing the display. Accordingly, a need exists for new ways to delivery electronic video and image content, particular on shaped surfaces that may conform to the content being projected.

### SUMMARY

A system for projecting content onto a shaped screen, consistent with the present invention, includes a projector configured for projecting electronic content having a particular shape and a rear projection screen for receiving and displaying the projected content. The rear projection screen has a shape substantially conforming to the particular shape of the projected content. The system is configured to increase an illumination of the projected content in a particular portion of the rear projection screen compared with the projected content in other portions of the rear projection screen.

A method for projecting content onto a shaped screen, consistent with the present invention, includes projecting electronic content having a particular shape and displaying the projected content on a rear projection screen. The rear projection screen has a shape substantially conforming to the particular shape of the projected content. The method also includes increasing the illumination of the projected content in a particular portion of the rear projection screen compared with the projected content in other portions of the rear projection screen.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of a system having a shaped rear projection screen and having content projected at a horizontal angle to the screen;

FIG. 2 is a perspective view of a system having a shaped rear projection screen and having content projected at a vertical angle to the screen;

FIG. 3 is a perspective view of a system having a shaped rear projection screen and having content projected to the screen by multiple projectors at horizontal and vertical angles;

FIG. 4 is a diagram of a shaped rear projection screen with a particular portion of the screen highlighted by an increase in brightness of the projected content in that portion; and

FIG. 5 is a diagram of another shaped rear projection screen with a particular portion of the screen highlighted by an increase in brightness of the projected content in that portion.

### DETAILED DESCRIPTION

Embodiments of the present invention include a system having a projector and a shaped rear projection screen with the system configured to increase or maximize the luminance of portions of interest on the screen. In digital merchandising applications, for example, a viewer's visual attention may be more attracted to brighter projected portions of images or video. Therefore, the system can increase the brightness to highlight a particular portion of the projected content, for example a product being advertised, a branded label for the product, or the face of a person presenting a product or service. A portion of the screen is a particular discrete area on the screen and can include multiple discrete areas collectively deemed a portion. An example of a portion having multiple discrete areas includes highlighting the face of a person presenting a product and a label on the product being presented. The electronic content projected and displayed can include electronic video content or changeable electronic (digital) still images.

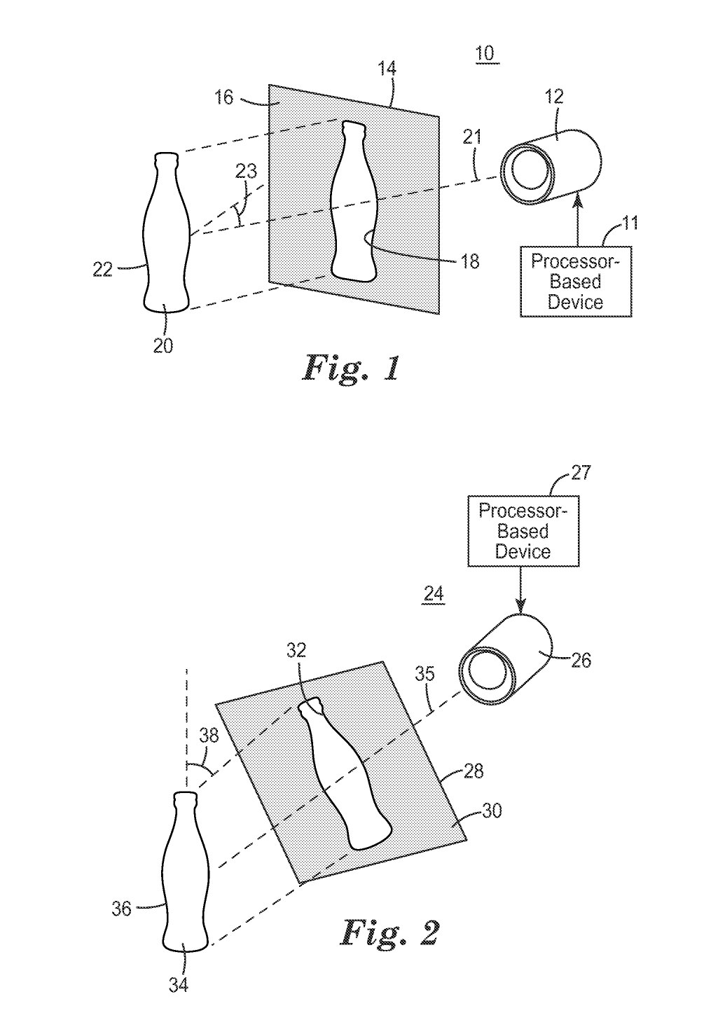

FIG. 1 is a perspective view of system 10 having a shaped rear projection screen and having content projected at a horizontal angle to the screen. System 10 includes a projector 12 for projecting changeable electronic content, a processor-based device 11 for electronically providing content to projector 12, a virtual mask 14 having a projection area 18, and a shaped rear projection screen 20. Processor-based device 11 can implement virtual mask 14 in software to effectively block content in region 16 such that the displayed content, as represented by line 21, is projected within projection area 18 and substantially conforms to the shape of projection screen 20 as defined by its outer edge 22. In system 10, the content is projected from projector 12 to projection screen 20 at a non-zero horizontal angle 23, meaning the content is projected at a horizontal angle with respect to an axis perpendicular to the screen.

FIG. 2 is a perspective view of system 24 having a shaped rear projection screen and having content projected at a vertical angle to the screen. System 24 includes a projector 26 for projecting changeable electronic content, a processor-based device 27 for electronically providing content to projector 26, a virtual mask 28 having a projection area 32, and a shaped rear projection screen 34. Processor-based device 27 can implement virtual mask 28 in software to effectively block content in region 30 such that the displayed content, as represented by line 35, is projected within projection area 32 and substantially conforms to the shape of projection screen 34 as defined by its outer edge 36. In system 24, the content is projected from projector 26 to projection screen 34 at a non-zero vertical angle 38, meaning the content is projected at a vertical angle with respect to an axis perpendicular to the screen.

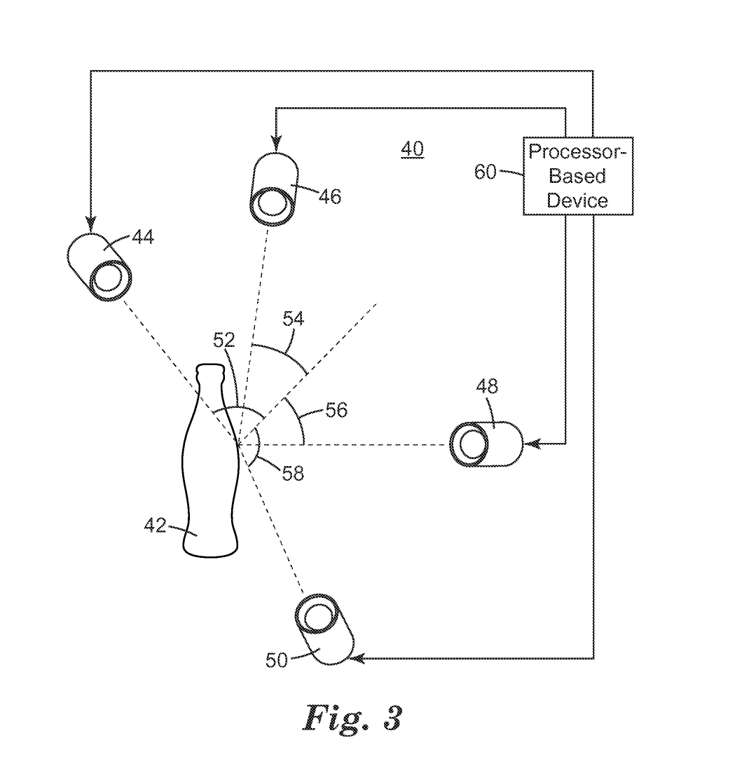

FIG. 3 is a perspective view of a system 40 having a shaped rear projection screen and having content projected to the screen by multiple projectors at horizontal and vertical angles. System 40 includes a shaped rear projection screen 42 and multiple projectors 44, 46, 48, and 50 projecting content to projection screen 42. Projectors 44 and 48 project content to projection screen 42 at non-zero horizontal angles 52 and 56, respectively. Projectors 46 and 50 project content to projection screen 42 at non-zero vertical angles 54 and 58, respectively. The projectors would also include virtual masks to shape the content projected onto the projection screen 42. The virtual masks are not shown in FIG. 3 for ease of illustration. A processor-based device 60 is electronically connected to projectors 44, 46, 48, and 50 in order to implement the virtual masks and provide shaped content to the projectors for projection of the content onto projection screen 42. Alternatively, multiple processor-based devices can be used for controlling the projectors. As illustrated by system 40, multiple projectors can be used to provide for projection of content at combinations of non-zero horizontal angles, non-zero vertical angles, or non-zero horizontal and vertical angles.

Shaped rear projection screens are described in U.S. Pat. No. 7,923,675, which is incorporated herein by reference as if fully set forth. Projection onto shaped and curved rear projection screens is described in U.S. patent application Ser. No. 13/195,965, entitled “Display System and Method for Projection onto Multiple Surfaces,” and filed Aug. 2, 2011, which is incorporated herein by reference as fully set forth. Examples of a rear projection screen and a projector are the VIKUITI XRVS Rear Projection Display Screen and the MPro 160 LCOS pico projector, both from 3M Company.

The systems can be configured to increase or maximize the brightness of a particular portion of projected content by varying the projection angle between the projector and rear projection screen. Rear projection screens typically have a transmission function for various input angles, which provides an indication of the illumination of the projected content based upon the projection angle including an area of increased or maximum brightness on the screen. From the transmission function, the projection angle can be optimized to provide an increased or the maximum visual brightness to an observer for a particular portion of the shaped rear projection screen. The projection angle (e.g., horizontal angle 23 and vertical angle 38) between the projector and rear projection screen can be varied by adjusting a position of the projector relative to the rear projection screen, adjusting a position of the rear projection screen relative to the projector, or adjusting positions of both the projector and rear projection screen. As shown in FIG. 3, multiple projectors can be used for projection at multiple non-zero angles for highlighting an area of interest in the projected content through increased brightness of a particular portion of the projection screen.

Aside from changing the angle between the projector and rear projection screen, the projected electronic content can be configured to increase the illumination of the projected content in a particular portion of the rear projection screen. In this case, the projector can project content directly onto the screen instead of at an angle, meaning the content is projected along an axis perpendicular to the screen. Alternatively, the portion of interest can have an increased illumination by both configuring the content and adjusting an angle between the projector and rear projection screen. Also, the content can be configured to increase the illumination of the content in different portions of the screen over time, for example when projecting video content, the highlighted portion can change along with the video content. The content can be configured by using digital video or imaging editing software programs to manually adjust the brightness of the portion of interest. Examples of digital content editing programs include the PHOTOSHOP products from Adobe Systems Incorporated and the FINAL CUT PRO product from Apple Incorporated. The content can also be modified by using keystone correction for the displayed image in the projector (typically up to ±30 degrees), by adjusting the content for the correct projection, or by both using keystone correction in the projector and adjusting the content.

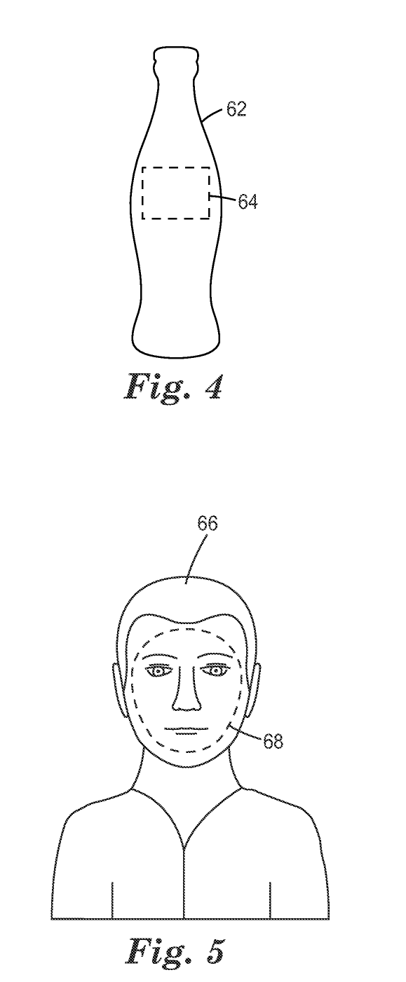

FIGS. 4 and 5 are diagrams of exemplary shaped rear projection screens with a particular portion of the screens having an increase in brightness of the projected content using the techniques and systems described herein. FIG. 4 illustrates a rear projection screen 62 having a bottle shape with a portion 64 having an increased or maximum brightness on the screen when displaying projected content. Portion 64 can represent a label for the bottle in order to highlight a particular brand, for example. FIG. 5 illustrates a rear projection screen 66 having the shape of a person (presenter) with a portion 68 having an increased or maximum brightness on the screen when displaying projected content. Screen 66 can display a video of the person presenting a product or service, for example, with the person's face (portion 68) having an increased or maximum brightness to highlight the person's presentation.

In the above description, a bottle or presenter shape is used as the shape of the rear projection screen for illustrative purposes only. The rear projection screens can be shaped to conform to any desired content to be projected upon them. Although a virtual mask having a projection area to create the particular shape of the content is described above, a physical mask can also be used to create the particular shape of the content, or both a virtual and a physical mask can be used.

1. A system for projecting content onto a shaped screen, comprising:
a projector configured for projecting electronic content having a particular shape; and
a rear projection screen for receiving and displaying the projected electronic content,
wherein the rear projection screen has a shape substantially conforming to the particular shape of the projected electronic content,
wherein the system is configured to increase an illumination of the projected electronic content in a particular portion of the rear projection screen compared with the projected electronic content in other portions of the rear projection screen.

2. The system of claim 1, wherein an angle between the projector and the rear projection screen is adjusted to increase the illumination of the projected electronic content in the particular portion of the rear projection screen.

3. The system of claim 1, wherein the projected electronic content is configured to increase the illumination of the projected electronic content in the particular portion of the rear projection screen.

4. The system of claim 1, wherein the projected electronic content in the particular portion has a maximum brightness on the rear projection screen.

5. The system of claim 1, wherein the projected electronic content comprises digital images.

6. The system of claim 1, wherein the projected electronic content comprises video.

7. The system of claim 1, wherein the particular portion comprises multiple discrete areas on the rear projection screen.

8. The system of claim 1, further comprising a mask, wherein the mask has a projection area determining the particular shape of the projected electronic content.

9. A method for projecting content onto a shaped screen, comprising:
projecting electronic content having a particular shape onto a rear projection screen;
displaying the projected electronic content on the rear projection screen, wherein the rear projection screen has a shape substantially conforming to the particular shape of the projected electronic content; and
increasing an illumination of the projected electronic content in a particular portion of the rear projection screen compared with the projected electronic content in other portions of the rear projection screen.

10. The method of claim 9, wherein the increasing step comprises adjusting an angle between the projector and the rear projection screen to increase the illumination of the projected electronic content in the particular portion of the rear projection screen.

11. The method of claim 10, wherein the increasing step comprises adjusting a position of the projector relative to the rear projection screen.

12. The method of claim 10, wherein the increasing step comprises adjusting a position of the rear projection screen relative to the projector.

13. The method of claim 9, wherein the increasing step comprises configuring the projected electronic content to increase the illumination of the projected electronic content in the particular portion of the rear projection screen.

14. The method of claim 9, wherein the increasing step comprises providing the projected electronic content in the particular portion with a maximum brightness on the rear projection screen.

15. The method of claim 9, wherein the projecting step comprises projecting digital images.

16. The method of claim 9, wherein the projecting step comprises projecting video.

17. The method of claim 16, wherein the increasing step comprises changing the particular portion of the rear projection screen having the increase in illumination of the projected electronic content during the display of the video.

18. The method of claim 9, wherein the increasing step comprises increasing the illumination in multiple discrete areas as the particular portion on the rear projection screen.

19. The method of claim 9, wherein the projecting step comprises using a mask to determine the particular shape of the projected electronic content.

20. The method of claim 9, wherein the projecting step comprises projecting the electronic content from multiple projectors.
